(19) United States
(12) Patent Application Publication
(10) Pub. No.: US 2010/0077439 A1
(43) Pub. Date: Mar. 25, 2010

(54) Method of Generating a Modification Signal and Infographic Sequence, Corresponding Source Signal, Infographic Sequence, Broadcasting Method and Device and Management System

(75) Inventor: Laurent Roger, Bruz (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: CINEACT, Rennes (FR)

(21) Appl. No.: 12/525,016

(22) PCT Filed: Jan. 22, 2008
(86) PCT No.: PCT/EP08/50683

§ 371 Date: Dec. 2, 2009

(30) Foreign Application Priority Data
Jan. 29, 2007 (FR) 07/00597

(51) Int. Cl. H04N 7/173

(52) U.S. Cl. 725/105

(57) ABSTRACT

A method and apparatus are provided for generating a modification signal intended to be used in a method of broadcasting an infographic sequence by a reproduction apparatus. The method includes inserting, into the modification signal, modification information relating to modifiable infographic compositions included in a modifiable infographic sequence. The modification signal makes it possible to modify the modifiable infographic sequence to obtain a modified infographic sequence intended to be broadcast by the reproduction.

### CROSS-REFERENCE TO RELATED APPLICATIONS

This Application is a Section 371 National Stage Application of International Application No. PCT/EP2008/050683, filed Jan. 22, 2008 and published as WO 2008/095770 on Aug. 14, 2008, not in English.

### STATEMENT REGARDING FEDERALLY SPONSORED RESEARCH OR DEVELOPMENT

None

### THE NAMES OF PARTIES TO A JOINT RESEARCH AGREEMENT

None

### FIELD OF THE DISCLOSURE

The field of the disclosure is that of audiovisual. More precisely, the disclosure relates to the broadcasting of infographic sequences. Such infographic sequences are already known from the prior art. They especially include the broadcasting of adverts, but are not restricted to this purpose. They are generally used to enrich audio and/or video programmes.

The disclosure especially applies to the public or private projections of films, music concerts, etc. but is not restricted to this purpose.

In the rest of this document, the following definitions will be used:

by infographic sequence, it is meant a succession of shots or scenes of a same subject and in which one or several infographic compositions are included;

by infographic composition, it is meant a graphic representation obtained using a computer by mathematical simulation of the factors composing the visual perception of an environment in three dimensions; and

by content, it is meant for example a fixed or animated image (film, video, etc.), text, sound or even an infographic composition as well as their visual and/or sound and/or temporal parameters or any combination of these elements.

### BACKGROUND OF THE DISCLOSURE

Below the disadvantages of the prior art are discussed through the specific case of the diffusion of infographic sequences, for example adverts, in cinemas.

The current audiovisual trend is broadcasting that is more interactive than before. There is now a desire to entertain the audience other than during the film projections and to interact with the audience via games or adverts.

Currently, two projection techniques are used in cinema halls.

A first technique is based on the implementation of 35 mm cinema projectors. This technique is known but presents a certain number of disadvantages.

Indeed, the ergonomics of this known technique is restricted by the fact that to broadcast the same infographic sequence in a large number of cinemas, it requires the sequence to be copied onto the 35 mm support (called the kinescopage technique) and a large number of copies to be made (generally one copy per cinema hall).

Another disadvantage of this first known technique lies in the fact that the flexibility of production is not optimal. The slightest modification (e.g. personalising the contents of the infographic compositions in function of the location of the projection, the audience watching, etc.) is long or even impossible.

A second projection technique consists of using digital cinema projectors.

Such a technique is especially described in the document FR 2 833 379. According to this second known technique, the digital compositions to be broadcast using digital projectors are determined in function of the audience data.

Even though the digital projection technique represents a major advance in the mechanism of the reproduction of infographic sequences (improved broadcast quality, no copies required), the second known technique nevertheless has the disadvantage of not allowing good reactivity (which is to say that it does not allow an infographic sequence to be modified at the last moment as a new coded file or support has to be generated using the method to read the composition (MPEG2, JPEG2000)), or to offer elaborate interactions, especially when an infographic sequences is broadcast.

### SUMMARY

An aspect of the disclosure relates to a method for generating a modification signal designed to be used in a method for broadcasting one infographic sequence by at least one reproduction device.

Such a method according to an embodiment of the invention comprises a step of inserting, in said modification signal, at least one item of modification information concerning at least one modifiable infographic composition that is included in a modifiable infographic sequence, wherein said modification signal permits said modifiable infographic sequence to be modified to obtain a modified infographic sequence designed to be broadcast by said at least one reproduction device.

Consequently, an embodiment of the invention proposes the modification of an infographic sequence in real time, for example, to adapt it to the location where it is broadcast or the audience to which it is broadcast. Contrary to the techniques of the prior art, it is therefore possible to modify a content when broadcasting the infographic sequence.

The fact that the modification information is inserted in a synchronised flow allows simple, precise and efficient synchronisation of the modified infographic sequences.

According to one advantageous aspect of an embodiment of the invention, the method comprises a step of inserting, in said modification signal, at least one characterisation frame, wherein each characterisation frame comprises an identification key of said frame and at least one command field comprising at least one of said items of modification information permitting the parameters at least part of said modifiable infographic sequence to be set.

Consequently, it is advantageously provided to secure the access and processing of the modification information. In one specific embodiment, the modification information is only processed if the identification key is identified positively, for example by an identification module built into the reproduction device.

Preferably, each characterisation frame comprises an item of routing information comprising at least one identifier of at least one reproduction device.

Consequently, it is advantageously provided to use in parallel several reproduction devices. The characterisation frames are directed to one or several reproduction devices which, in function of the routing information, authorise or prevent the extraction and the processing of the modification information.

Advantageously, said at least one item of modification information belongs to the group comprising:

one item of identification information of at least one given modifiable infographic composition, and/or at least one given modifiable content;

one item of information that is representative of a visual and/or sound parameter of at least one given modifiable infographic composition or at least one given modifiable content;

one item of information that is representative of a temporal parameter of at least one given modifiable infographic composition or at least one given modifiable content.

In one preferred embodiment of the invention, the method comprises a step of inserting, in said modification signal, at least one item of information belonging to the group comprising:

information for supervising said at least one reproduction device;

programming information for programming the broadcasting of the infographic sequences modified by said at least one reproduction device;

interconnection information permitting the interconnection of several reproduction devices to one another.

An embodiment of the invention also relates to a modification signal designed to be used in a method for broadcasting an infographic sequence by at least one reproduction device. According to an embodiment of the invention, the modification signal comprises at least one item of modification information related to at least one modifiable infographic composition included in a modifiable infographic sequence, wherein said modification signal permits said modifiable infographic sequence to be modified to obtain a modified infographic sequence designed to be broadcast by said at least one reproduction device.

An embodiment of the invention also relates to a means of storage, that may be partially or completely removable, containing at least one modification signal that may be read by a computer and generated according to the (modification signal) generation method mentioned above.

An embodiment of the invention further relates to a computer program comprising program code instructions for the execution of the (modification signal) generation method steps mentioned above, when said program is run on a computer.

An embodiment of the invention further relates to a method for generating an infographic sequence designed to be used in a method for broadcasting an infographic sequence by at least one reproduction device. The infographic sequence comprises at least one infographic composition, wherein each infographic composition comprises at least one content.

Such a method according to an embodiment of the invention comprises a step of inserting at least one modifiable infographic composition in said infographic sequence, permitting a modifiable infographic sequence to be obtained that is designed to be modified in function of a modification signal, to obtain a modified infographic sequence designed to be broadcast by said at least one reproduction device.

According to one advantageous aspect of an embodiment of the invention, the method comprising said modifiable infographic sequence comprises at least one modifiable parameter belonging to the group comprising:

one visual and/or sound parameter of at least one given modifiable infographic composition or at least one given item of modifiable data;

one temporal parameter of at least one modifiable infographic composition or at least one given modifiable content.

An embodiment of the invention also relates to an infographic sequence designed to be used in a method for broadcasting an infographic sequence by at least one reproduction device. The infographic sequence comprises at least one infographic composition, wherein each infographic composition comprises at least one content. According to an embodiment of the invention, the infographic sequence comprises at least one modifiable infographic composition, permitting a modifiable infographic sequence to be obtained designed to be modified in function of a modification signal, to obtain a modified infographic sequence designed to be broadcast by said at least one reproduction device.

An embodiment of the invention also relates to a means of storage, that may be partially or completely removable, containing at least one modifiable infographic sequence that may be read by a computer or a reproduction device and generated according to the (infographic sequence) generation method mentioned above.

An embodiment of the invention further relates to a computer program comprising program code instructions for the execution of the steps of the (infographic sequence) generation method mentioned above, when said program is run on a computer.

Another aspect of an embodiment of the invention relates to a method for broadcasting an infographic sequence by at least one reproduction device. The infographic sequence comprises at least one infographic composition, wherein each infographic composition comprises at least one content.

Such a method according to the an embodiment of invention comprises the following steps, for each reproduction device:

the obtaining of a modifiable infographic sequence comprising at least one modifiable infographic composition;

the obtaining of a modification signal comprising at least one item of modification information concerning said at least one modifiable infographic composition;

the generation of a modified infographic sequence, by modification of said modifiable infographic sequence in function of said modification signal;

the broadcasting of said infographic sequence modified by said reproduction device.

According to one advantageous aspect of an embodiment of the invention, said step of generating a modified infographic sequence comprises the following steps:

extraction of said at least one item of modification information;

insertion into said at least one modifiable infographic composition of said at least one item of modification information extracted.

An embodiment of the invention also relates to a computer program comprising program code instructions for the execution of the steps of the broadcasting method mentioned above, when said program is run on a computer.

An embodiment of the invention further concerns a broadcasting device comprising an infographic sequence reproduction device. The infographic sequence comprises at least one infographic composition, wherein each infographic composition comprises at least one content. According to an embodiment of the invention, the broadcasting device comprises:

means of obtaining a modifiable infographic sequence comprising at least one modifiable infographic composition;

means of obtaining a modification signal comprising at least one item of modification information concerning said at least one modifiable infographic composition;

means of generating a modified infographic sequence, by modification of the modifiable infographic sequence in function of said modification signal.

An embodiment of the invention also relates to an infographic sequence management system comprising:

at least one device for generating a modifiable infographic sequence comprising at least one modifiable infographic composition;

at least one device for generating a modification signal comprising at least one item of modification information concerning said at least one modifiable infographic composition;

at least one broadcasting device as mentioned above.

### BRIEF DESCRIPTION OF THE DRAWINGS

List of figures

Other features and advantages will become clearer upon reading the following description of a preferred embodiment, provided purely by way of illustration and in no way restrictively, and the appended drawings, among which:

FIG. 1 shows a simplified block diagram of a specific embodiment of an infographic sequence management system of the invention;

FIG. 2 shows a simplified block diagram of a specific embodiment of a device for generating modified infographic sequences of the invention;

FIG. 3 shows diagrammatically the structure of a specific embodiment of a modification signal of the invention; and

FIG. 4 shows an organisation diagram of a specific embodiment of the broadcasting method of the invention.

### DETAILED DESCRIPTION OF ILLUSTRATIVE EMBODIMENTS

The general principle of an embodiment of the invention is based on the production of a signal (called modification signal), comprising modification information, used to modify infographic sequences. Consequently, according to an embodiment of the invention, it is possible to generate the modification signal at any time, especially during the broadcasting of infographic sequences. In other terms, it is possible to modify the infographic sequences while they are being broadcast, which is not possible with the techniques of the prior art.

It is also possible to provide a modification information routing technique which permits distinct modified infographic sequences to be obtained and reproduced (in distinct cinema halls). Such a routing technique may especially command in parallel several devices for broadcasting infographic sequences, located in distinct locations.

In order to simplify the description, the rest of the document will simply describe the specific case of the broadcasting of adverts in a cinema. A person skilled in the art may extend this technique to all types of broadcasting of infographic sequences in several cinemas and to other reproduction supports than a cinema screen.

1. Infographic sequence management system

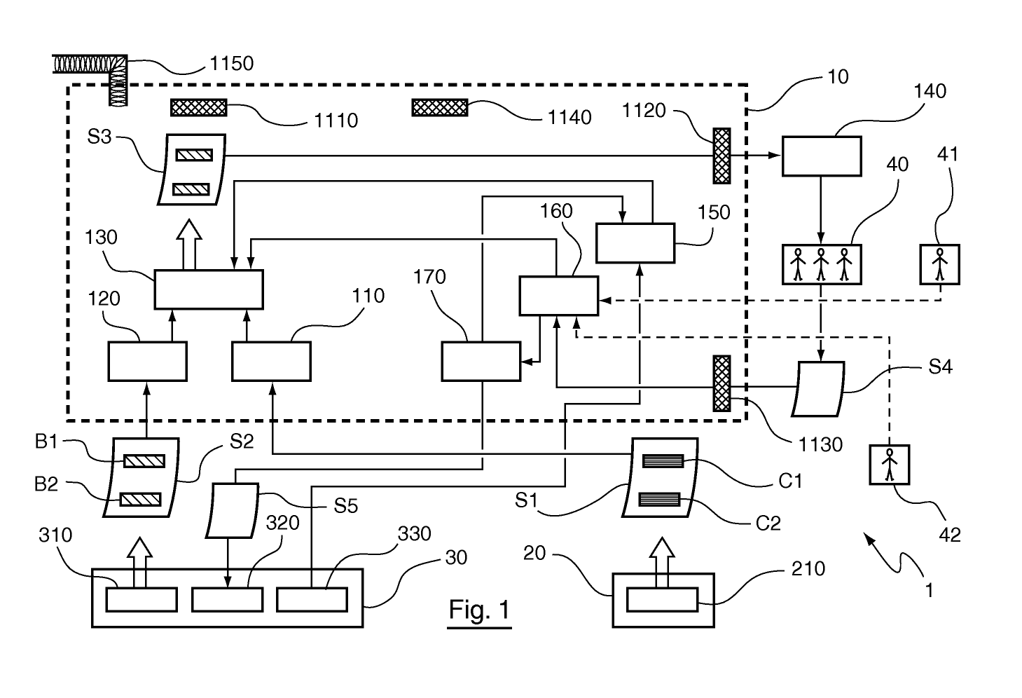

Now in relation to FIG. 1, an example of a infographic sequence management system will be described according to a preferred embodiment of the invention.

In this embodiment, the management system 1 comprises:

a device 210 for generating a modifiable infographic sequence S1 comprising first C1 and second C2 modifiable infographic compositions. In this embodiment, the generating device 210 is incorporated into a production appliance 20;

a device 310 for generating a modification signal S2 comprising first B1 and second B2 items of modification information related to first C1 and second C2 modifiable infographic compositions, respectively. As illustrated, the generating device 310 is incorporated into a programming and monitoring appliance 30.

a broadcasting device 10 comprising:

means 110 of obtaining the modifiable infographic sequence S1;

means 120 of obtaining the modification signal S2;

modification means 130 (also called hereunder modified infographic sequence generating device) which receive at their input the modifiable infographic sequence S1 and the modification signal S2 and which provide at their output a modified infographic sequence S3. As will be seen in the description, the modification of the modifiable infographic sequence S1 consists of inserting into the latter the first B1 and second B2 items of modification information;

a reproduction device 140, of the usual type (e.g. a D-Cinema or E-Cinema digital projector), capable of reproducing infographic sequences to spectators 40 in the cinema hall;

programmed broadcasting means 150 which permit the programming of the infographic sequences modified in a determined period (for example a week) to be defined;

interaction means 160 which allow spectator data S4 to be collected and to act on the modification means 130 in function of the data collected. In one variant of the embodiment, spectators 40 can interact with the management system 1 by means of a man/machine interface connected via a wireless connection (for example a Wifi or Bluetooth type radio connection) to the interaction means 160. In another variant of the embodiment, the spectator data may also be collected by one or several sensors (e.g. movement sensors, sound sensors, etc.) installed in the cinema hall. In another variant of the embodiment, the data may also be provided by an in situ 41 or remote 42 operator. All of these variants may be combined with one another;

synthesis means 170 capable of:

collecting information (for example the number of spectators, the reactions or the choice of the hall or spectators) from the interaction means 160;

acting on the programmed broadcasting means 150 in function of the interactions conceived on the production appliance 20;

transmitting synthetic information S5 (e.g. in addition to the above examples, statistics, slips, diagnoses) to the programming and monitoring appliance 30.

In the embodiment illustrated, the programming and monitoring appliance 30 further comprises a monitoring module 320 which receives synthetic information S5 and allows a diagnosis to be made (based on the synthetic information S5 received) on the state of operation of the broadcasting device 10, and if required, to correct the dysfunctions detected (e.g. by updating the programmed broadcasting means 150). The programming and monitoring appliance 30 also comprises a programming module 330 which permits the programming of the infographic sequences to be broadcast by the broadcasting device 10 to be defined and to transmit this programming to the programmed broadcasting means 150 (via a communication network for example).

As illustrated in FIG. 1, the broadcasting device 10, the production appliance 20 and the programming and monitoring appliance 30 may be incorporated into distinct housings. The broadcasting device 10 may be fitted into a housing installed in the cinema hall, presenting in one specific embodiment the following input/output elements:

a plug 1110 (of the Ethernet or Wifi type, etc.) for connection to a communication network;

a plug 1120 (of the DVI, HDMI, BNC type, etc.) for connection to an infographic sequence reproduction device 140 and/or a sound reproduction device;

a plug 1130 (of the Bluetooth, Wifi, wire, audio, optical type, etc. to be connected to a man/machine interface permitting a spectator to interact with the management system 1;

a plug 1140 of the DB25, SPDIF, RCA type, etc.) for connection to an audio and/or video reproduction device; and

a plug 1150 for the electrical power supply.

It is important to note that in one specific embodiment, a device 310 for generating a modification signal S2 may also be installed in each broadcasting device 10 and each production appliance 20.

It may be noted that the production appliance 20 may be used, for example, by producers of infographic sequences, advertising agencies, operators of cinema halls or advertising brokers.

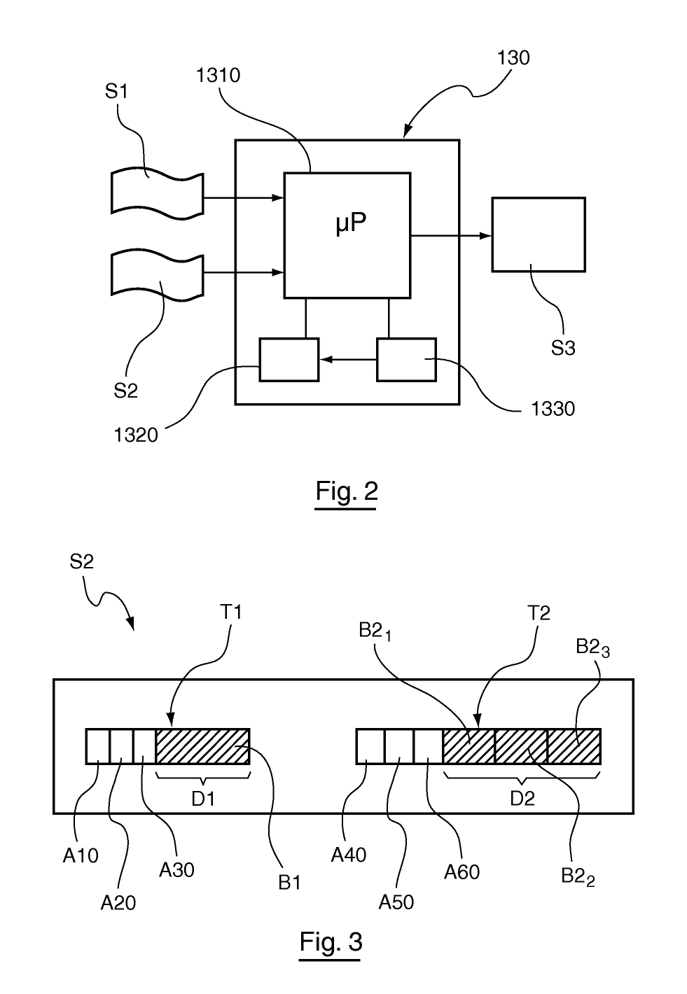

FIG. 2 presents in more detail the structure of the device 130 for generating modified infographic sequences according to an embodiment of the invention, which comprises a memory 1320, and a processing unit 1310 equipped with a microprocessor μP, which is piloted by a computer program (or application) 1330. The processing unit 1310 receives on a first input a modifiable infographic sequence S1 and on a second input a modification signal S2. The microprocessor μP processes this information, according to the instructions of the program 1330, to extract the information to modify the signal S2 and to generate a modified infographic sequences S3, which is transmitted to a reproduction device 140 (FIG. 1).

It may be noted that the invention is not restricted to a purely hardware installation but may also be implemented in the form of a sequence of instructions of a computer program or any other form combining hardware and software. In the case where an embodiment of the invention is installed partially or completely in software form, the corresponding sequence of instructions may be stored in storage means (such as a disk for example, a CD ROM or a DVD ROM) that may be removable or not, wherein these storage means may be read partially or completely by a computer or a microprocessor.

2. Structure of a modification signal

As already stated, the modification signal of an embodiment of the invention comprises modification information concerning one or several modifiable infographic compositions that are comprised in a modifiable infographic sequence.

In relation to FIG. 3, the structure of a modification signal S2 is presented diagrammatically according to one preferred embodiment of the invention.

In this embodiment, the modification signal S2 comprises:

a first characterisation frame T1, comprising a first identification key A10, an identifier A20 of the generating device 130, an identifier A30 of the first modifiable infographic compositions C1 and a first command field D1 comprising the first item of modification information B1 (for example a fixed image) which permits the parameters of the first modifiable infographic composition C1 of the modifiable infographic sequence S1 to be set. It is important to note that the first three items of information, A10, A20 and A30 allow the start of the first frame T1 to be marked. When the device 130 for generating the modifiable infographic sequences encounters such information, it knows directly that this concerns a characterisation frame that is designed to modify the first modifiable infographic composition C1;

a second characterisation frame T2 comprising a second identification key A40, the identifier A50 of the generating device 130, an identifier A60 of the second modifiable infographic composition C2 and a second command field D2 comprising second B2₁ (e.g. an animated image), third B2₂ (e.g. an item of information that is representative of a broadcast duration) and fourth B2₃ (e.g. an item of information that is representative of a musical sequence to be played) modification information permitting the parameters of the second modifiable infographic composition C2 in the modifiable infographic sequence S1 to be set. It is important to note that the three first items of information A40, A50 and A60 permit the start of the second frame T2 to be marked. When the device 130 for generating modified infographic sequences encounters such information, it knows directly that this concerns a characterisation frame that is designed to modify the second modifiable infographic composition C2.

3. Broadcasting of a modified infographic sequence

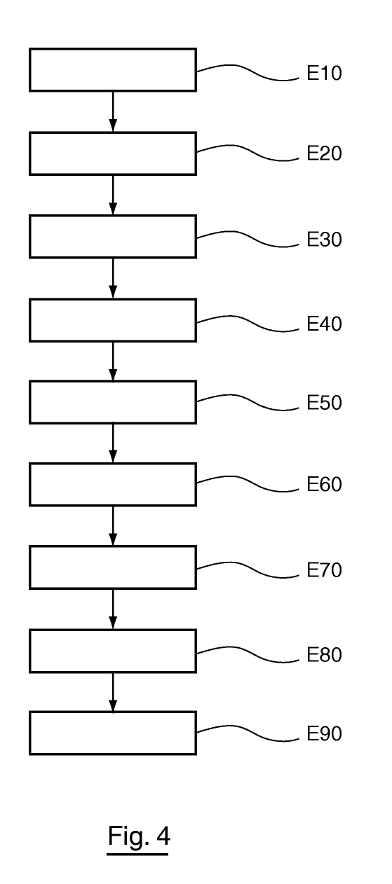

In relation to FIG. 4, an organisation diagram globally showing a broadcasting method according to one preferred embodiment of the invention is presented.

In a first step E10 in function of specifications set by a customer, a modifiable infographic sequence is composed (e.g. an advert for a rally car) into which one or several modifiable infographic compositions have been inserted (e.g. the logos of the sponsors of the car are modifiable).

In one step E20, one or several items of modification information are defined (or selected from a data base) (e.g. logos (fixed or animated images)).

In a step E30, the modification information defined in step E20 is inserted into a medication signal.

In a step E40, a modifiable infographic sequence comprising a plurality of modifiable infographic compositions is received.

In a step E50, a modification signal comprising a plurality of items of modification information is received.

In a step E60, the various items of modification information are detected in the modification signal.

In a step E70, the items of modification information detected in step E60 are extracted and directed to a modified infographic sequence generating device.

Then, in a step E80, the items of modification information received by the modified infographic sequence generating device (received in step E40) are inserted in the modifiable infographic sequence, so as to obtain a modified infographic sequence.

Finally, in a step E90, the modified infographic sequence obtained in step E80 is reproduced, via, for example, a D-Cinema digital projector.

At least one embodiment of the present disclosure provides a technique for broadcasting infographic sequences that is simple and efficient to use, especially in terms of reactivity.

At least embodiment provides such a technique that permits improved flexibility of production and broadcasting.

At least one embodiment provides such a technique which permits real time modification of the infographic compositions (especially when they are broadcast).

At least one embodiment provides such a technique which is compatible with the existing digital projectors.

At least one embodiment provides such a reproduction technique which has a simple design and is inexpensive.

Although the present disclosure has been described with reference to one or more examples, workers skilled in the art will recognize that changes may be made in form and detail without departing from the scope of the disclosure and/or the appended claims.

1-18. (canceled)

19. A method for generating a modification signal designed to be used in a method for broadcasting an infographic sequence by at least one reproduction device, wherein the method comprises the following steps:
generating, during the broadcasting of said infographic sequence, at least one item of modification information concerning at least one three dimensional modifiable infographic composition comprised in said infographic sequence;
inserting, in said modification signal, said at least one item of modification information, wherein said modification signal permits said infographic sequence, called modifiable, to be modified to obtain a modified infographic sequence designed to be broadcast by said at least one reproduction device.

20. The method according to claim 19, wherein the method comprises a step of inserting, in said modification signal, at least one characterisation frame, wherein each characterisation frame comprises an identification key for said frame and at least one command field comprising at least one of said items of modification information permitting parameters of at least one part of said modifiable infographic sequence to be set.

21. The method according to claim 20, wherein each characterisation frame comprises an item of routing information comprising at least one identifier of at least one reproduction device.

22. The method according to claim 19, wherein said at least one item of modification information belongs to the group comprising:
one item of identification information of at least one given three dimensional modifiable infographic composition, and/or of at least one given modifiable content;
one item of information that is representative of a visual and/or sound parameter of at least one given three dimensional modifiable infographic composition or of at least one given modifiable content;
one item of information that is representative of a temporal parameter of at least one given three dimensional modifiable infographic composition or of at least one given modifiable content.

23. The method according to claim 19, wherein the method comprises a step of inserting, in said modification signal, at least one item of information belonging to the group comprising:
monitoring information of said at least one reproduction device;
programming information permitting the broadcasts of infographic sequences modified by said at least one reproduction device to be programmed;
interconnection information permitting at least two reproduction devices to be connected to one another.

24. A method comprising:
generating a modification signal, which comprises at least one item of modification information generated during broadcasting of a modified infographic sequence and that is related to at least one three dimensional modifiable infographic composition comprised in a modifiable infographic sequence;
modifying said modifiable infographic sequence by said modification signal to obtain the modified infographic sequence; and
broadcasting the modified infographic sequence by at least one reproduction device.

25. A method for generating an infographic sequence designed to be used in a method for broadcasting an infographic sequence by at least one reproduction device, wherein said infographic sequence comprises at least one infographic composition, wherein each infographic composition comprises at least one content, wherein said method comprises:
inserting at least one three dimensional modifiable infographic composition into said infographic sequence, permitting a modifiable infographic sequence to be obtained designed to be modified in function of a modification signal, to obtain a modified infographic sequence designed to be broadcast by said at least one reproduction device.

26. The method according to claim 25, wherein said modifiable infographic sequence comprises at least one modifiable parameter which belongs to the group comprising:
a visual and/or sound parameter of at least one given three dimensional modifiable infographic composition or of at least one given modifiable content;
a temporal parameter of at least one given three dimensional modifiable infographic composition or of at least one given modifiable content.

27. A method comprising:
broadcasting an infographic sequence by at least one reproduction device, wherein said infographic sequence comprises at least one infographic composition, wherein each infographic composition comprises at least one content, wherein broadcasting comprises the following steps, for each reproduction device:
obtaining a modifiable infographic sequence comprising at least one three dimensional modifiable infographic composition;
obtaining a modification signal comprising at least one item of modification information generated during the broadcasting of said infographic sequence and that is related to said at least one three dimensional modifiable infographic composition;
generating a modified infographic sequence, by modification of said modifiable infographic sequence in function of said modification signal;
broadcasting said modified infographic sequence by said reproduction device.

28. The method according to claim 27, wherein said step of generating a modified infographic sequence comprises the following steps:
extracting said at least one item of modification information;
inserting in said at least one three dimensional modifiable infographic composition said at least one item of modification information extracted.

29. A broadcasting device comprising:
means for obtaining a modifiable infographic sequence comprising at least one three dimensional modifiable infographic composition;
means for obtaining at least one item of modification information generated during broadcasting said infographic sequence and that is related to said at least one three dimensional modifiable infographic composition;
means for obtaining a modification signal comprising said at least one item of modification information;
means for generating a modified infographic sequence, by modification of said modifiable infographic sequence in function of said modification signal.

30. An infographic sequence management system comprising:
at least one device for generating a modifiable infographic sequence comprising at least one three dimensional modifiable infographic composition;
at least one device for generating, during broadcasting of said infographic sequence, at least one item of modification information that is related to at least one three dimensional modifiable infographic composition comprised in said infographic sequence;
at least one device for generating a modification signal comprising said at least one item of modification information;
at least one device for generating a modified infographic sequence, by modification of said modifiable infographic sequence as a function of said modification signal.
